(19) United States
(12) Patent Application Publication
(10) Pub. No.: US 2012/0127317 A1
(43) Pub. Date: May 24, 2012

(54) METHOD AND DEVICE TO SECURELY OPEN AND CLOSE A PASSAGEWAY OR ACCESS POINT

(75) Inventors: Thomas Michael Yantek, Lawrence, PA (US); Timothy U. Craddock, Duquesne, PA (US); Anthony Kenneth Gianettino, Canonsburg, PA (US); Joseph Mark Mulcahy, Beaver Falls, PA (US); Randy William Wickman, Beaver, PA (US)

(73) Assignee: BEA, INC., Pittsburgh, PA (US)

(21) Appl. No.: 13/297,301

(22) Filed: Nov. 16, 2011

Related U.S. Application Data
(60) Provisional application No. 61/415,511, filed on Nov. 19, 2010.

(51) Int. Cl. H04N 7/18

(52) U.S. Cl. 348/156; 348/E07.085

(57) ABSTRACT

An access control system for a passageway having a passageway barrier including an active infrared sensor device and a locking mechanism for selectively locking and unlocking the passageway barrier. The active infrared sensor device includes an infrared emitter, an infrared receiver having one or more position-sensing photodetectors operative for receiving infrared light and generating a signal corresponding to a position and/or intensity of the reflected infrared light, and a processing unit operative for detecting a change between a first signal generated by one or more position-sensing photodetectors after receiving reflected infrared light at a first location on one or more position-sensing photodetectors and a second signal generated by one or more position-sensing photodetectors after receiving infrared light reflected in response to the object moving into the surveillance area and for controlling an operation of a locking mechanism based on the change.

### CROSS-REFERENCE TO RELATED APPLICATION

This application claims priority to U.S. Provisional Patent Application No. 61/415,511, filed Nov. 19, 2010, entitled “Method and Device to Securely Open and Close a Passageway or Access Point”, the entire disclosure of which is herein incorporated by reference.

### BACKGROUND OF THE INVENTION

1. Field of the Invention

This invention relates, in general, to a sensor device, and more particularly, to a sensor device especially applicable for security doors wherein a request to exit or enter a secure side of a door is determined by sensing for the presence of an object, such as a person's hand, within a surveillance area.

2. Description of the Related Art

Motion sensors are commonly utilized to detect presence and motion within a surveillance area. Such sensors may be used in a variety of applications, including door sensor devices particularly adapted to detect a presence of an object near a passageway or an access point. In such applications, presence and/or motion are detected when an object, such as a person's hand, enters a detection area of the sensor. Upon detection, the motion sensor triggers the opening or closing of a locking mechanism to control access to the passageway.

A plurality of sensor technologies may be utilized for motion detection. Sensors used in automatic door applications are commonly based on thermal or infrared technology. Such sensors detect thermal radiation emitted by an object and are operated by detecting an object having a thermal signature that is different from its environment. Well-known request-to-exit sensor technology is based on passive infrared (PIR) devices. These devices do not emit infrared radiation to perform detection, but rather detect infrared radiation emitted by an object to be detected. A typical PIR device includes a plurality of optical components to detect infrared radiation emitted by an object. Such devices are typically tuned for detecting radiation having a wavelength between 7 and 14 μm. These devices have a broad field of detection, often several feet from the door. Despite the widespread use of PIR sensor technology, there exist a number of disadvantages.

PIR devices are susceptible to false activation, activation by unscrupulous activity, or activation by thermal changes near a passageway. Pedestrian traffic passing by a passageway controlled by the PIR device often leads to false activation of the door. Even after adjusting the PIR device to minimize its activation zone, false door activations can still arise due to any of the above-identified factors. Furthermore, it is common practice to place heating and cooling devices near doorways, which can further complicate the problem of false activations by affecting the thermal sensitivity of the PIR device.

An additional drawback of conventional PIR devices is their susceptibility to false activation and/or inoperation due to electromagnetic interference. Automatic door mechanisms are often equipped with highly inductive magnetic locks that create powerful electromagnetic fields during activation. This may lead to electromagnetic interference that in turn may lead to a failure of electronic devices that share the same circuit with the automatic door mechanism. In order to overcome this problem, conventional PIR devices must either be powered by a different circuit from the automatic door mechanism, or include additional surge protection in the wiring. These additional features lead to increased cost for manufacturing and/or installing the PIR device.

In view of the foregoing, a need exists for a method and device to securely open and close a passageway or access point by sensing a request to exit or enter a secure side of a door and minimizing false activations.

### SUMMARY OF THE INVENTION

The claimed invention is directed to a method and device to securely open and close a passageway or access point by detecting a presence of an object, for example a human hand, and controlling operation of a door regulating access to and from a passageway.

According to one embodiment of the present invention, an active infrared sensor device may include at least one infrared emitter operative for emitting a pattern of infrared light to define a surveillance area, at least one infrared receiver having one or more position-sensing photodetectors (PSDs) operative for receiving infrared light reflected from the surveillance area and for generating a signal corresponding to a position and/or intensity of the reflected infrared light, and a processing unit operative for detecting a change between a first signal generated by the one or more PSDs after receiving reflected infrared light prior to an object moving into the surveillance area at a first location on the one or more PSDs and a second signal generated by the one or more PSDs after receiving infrared light reflected from the object after moving into the surveillance area at a second location on the one or more PSDs. The processing unit may additionally be operative for controlling an operation of a locking mechanism of a passageway barrier based on said change. The one or more PSDs can include a lateral PSD or a segmented PSD.

In accordance with this embodiment, the processing unit may cause the locking mechanism to unlock the passageway barrier in response to the processing unit detecting said change and may cause the locking mechanism to either lock the passageway barrier or maintain the passageway barrier locked in response to the processing unit not detecting the change.

According to another embodiment of the present invention, the active infrared sensor device may further include one or more optical elements in the path of the at least one infrared emitter or the at least one infrared receiver. The optical elements may have high transmissivity to infrared radiation and low transmissivity to radiation outside the infrared spectrum.

According to yet another embodiment of the present invention, the active infrared sensor device may further include one or more mechanical clips having a plurality of angle adjustment notches corresponding to a plurality of detection angles of the at least one infrared emitter or the at least one infrared receiver. The detection angle may be adjusted by pivoting the at least one infrared emitter or the at least one infrared receiver to engage an angle adjustment notch. The sensor device may optionally include a sounding device activated by an unlocked state of the locking mechanism.

In accordance with another embodiment of the present invention, a method of controlling a locking mechanism may include the steps of: (a) providing a sensor device configured to detect an object within a surveillance area, the sensor device including: at least one infrared emitter operative for emitting infrared light to define the surveillance area; at least one infrared receiver having one or more position-sensing photodetectors (PSDs) operative for receiving infrared light reflected from the surveillance area and for generating a signal corresponding to a position and/or intensity of the reflected infrared light; and a processing unit; (b) the infrared emitter emitting infrared radiation; and (c) the one or more PSDs generating a first signal in response to receiving reflected infrared light prior to the object moving into the surveillance area at a first location on the one or more PSDs and the one or more PSDs generating a second signal in response to receiving infrared light reflected from the object after moving into the surveillance area. The one or more PSDs can include a lateral PSD or a segmented PSD. The method further includes the steps of: (d) the processing unit detecting a change between the first and second signals; and (e) the processing unit controlling an operation of the locking mechanism based on said change.

The method may further include the steps of: (f) receiving a signal from a security device; and (g) sending a signal to a remote device. In this embodiment, the security device may be a passageway switch, a push plate, an emergency door release button, a mechanical hardware lock and key, an electronic security card reader, an encrypted key-fob receiver, a secure biometric reader, an RFID tag transponder, or a video identification system. The remote device may be a fire alarm or a video system.

In accordance with another embodiment of the present invention, the method may further include the steps of receiving a signal from an appliance corresponding to an open, a closed, or a transitional state of the passageway barrier and using one or more sensing means, including capacitive, inductive, magnetic, microwave, optical, and physical contact, to monitor the state of the passageway barrier. In this embodiment, the appliance may be a magnetic reed switch, an optical encoder, a gyroscope, a photo-eye, magnetometer or a mechanical switch. According to another embodiment of the present invention, a sounding device activated by an unlocked state of the locking mechanism may also be provided.

According to a further embodiment of the present invention, an access control system may include a passageway having a passageway barrier for selectively controlling access through the passageway, an active infrared sensor device for detecting an object within a surveillance area adjacent to the passageway, and a locking mechanism operative for selectively locking and unlocking the passageway barrier in response to the active infrared sensor device not detecting and detecting, respectively, the object within the surveillance area.

In accordance with this embodiment, the active infrared sensor device may include an infrared emitter operative for emitting a pattern of infrared light to define the surveillance area; an infrared receiver having one or more position-sensing photodetectors (PSDs) operative for receiving infrared light reflected from the surveillance area and for generating a signal corresponding to a position and/or intensity of the reflected infrared light; and a processing unit operative for detecting a change between a first signal detected by the one or more PSDs in response to receiving reflected infrared light prior to an object moving into the surveillance area at a first location on the one or more PSDs and a second signal detected by the one or more PSDs in response to receiving infrared light reflected from the object after moving into the surveillance area at a second location on the one or more PSDs and for controlling an operation of a locking mechanism of a passageway barrier based on said change. The one or more PSDs can include a lateral PSD or a segmented PSD.

According to yet another embodiment of the present invention, the processing unit may cause the locking mechanism to unlock the passageway barrier in response to the processing unit detecting the change between the first and second signals generated by the one or more PSDs that is above a predetermined threshold value and control the locking mechanism to either lock the passageway barrier or maintain the passageway barrier locked in response to the processing unit detecting the change between the first and second signals generated by the one or more PSDs that is below the predetermined threshold value. One or more mechanical clips may also be provided, the mechanical clips having a plurality of angle adjustment notches corresponding to a plurality of detection angles of the infrared emitter or the infrared receiver, wherein the detection angle is adjusted by pivoting the infrared emitter or the infrared receiver to engage an angle adjustment notch. A security device may be provided adjacent to the passageway, the security device being operative for opening the passageway barrier. In accordance with this embodiment, the security device may be a passageway switch, a push plate, an emergency door release button, a mechanical hardware lock and key, an electronic security card reader, an encrypted key-fob receiver, a secure biometric reader, an RFID tag transponder, or a video identification system.

Further details and advantages of the present invention will become apparent from the following detailed description read in conjunction with the drawings.

### BRIEF DESCRIPTION OF THE DRAWINGS

FIG. 1 is a perspective view of the passageway access control system according to an embodiment of the present invention;

FIG. 2 is a perspective view of a sensor device;

FIG. 3 illustrates a block diagram of various components of a sensor device in accordance with an embodiment of the present invention;

FIGS. 4A-4C are side views of a mechanical means for adjusting the detection angle of the sensor device in accordance with an embodiment of the present invention;

FIGS. 5A and 5B show the change in the angles of reflection of the signals detected by the sensor device between multiple operating conditions according to one embodiment;

FIGS. 6A and 6B show the change in the angles of reflection of the signals detected by the sensor device between multiple operating conditions according to another embodiment;

FIG. 7 is a flow chart of a method for using the sensor device in accordance with an embodiment of the present invention; and

FIG. 8 is a flow chart of a method for using the sensor device in accordance with a further embodiment of the present invention.

### DETAILED DESCRIPTION OF THE INVENTION

Referring to the drawings in which like reference characters refer to like parts throughout the several views thereof, the present invention is generally described in terms of a device and a method applicable to security doors wherein a request to exit or enter a secure side of a door is determined by sensing for the presence of an object, such as a person's hand, within a surveillance area. Within the present disclosure, the term “signal”, whether or not used in combination with a descriptive label such as “optical” or “electrical”, means any quantity measurable through time or over space, where such quantity is capable of being emitted by an object or component or received by the same.

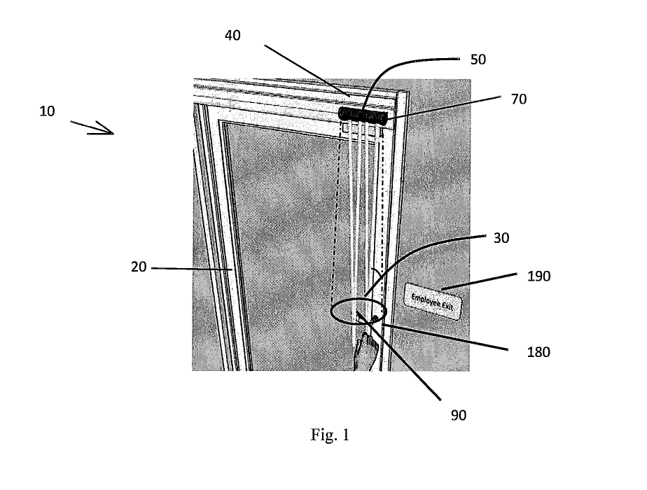

FIG. 1 is a front perspective view of a passageway access control system 10 according to an embodiment of the present invention. System 10 opens and closes, or unlocks and locks, a passageway barrier, such as a door 20, formed through a passageway. Door 20 is illustrated in FIG. 1 as a swinging door; however, system 10 may be used with a plurality of other door types, including sliding and revolving doors. A sensor device 40 is positioned above door 20 to sense the presence of an object within a surveillance area 30.

With continuing reference to FIG. 1, sensor device 40 includes a housing 50 mounted proximate to door 20. Sensor device 40 may be mounted in any one of a plurality of locations proximate to a passageway. In one non-limiting embodiment, sensor device 40 is positioned on a top part of door 20 or a door frame. In such applications, sensor device 40 is mounted such that it projects a pattern of infrared radiation to define surveillance area 30 in the vicinity of the passageway. Alternatively, sensor device 40 may be positioned in a location above or to the side of the passageway. Sensor device 40 may be mounted on the door frame immediately above door 20. Sensor device 40 is desirably positioned in a lateral direction such that it is directly above a passageway element, such as a door handle 90. In various applications, sensor device 40 may be associated with swinging, sliding, or revolving doors. A plurality of sensor devices 40 may be installed to securely control access to and from a passageway.

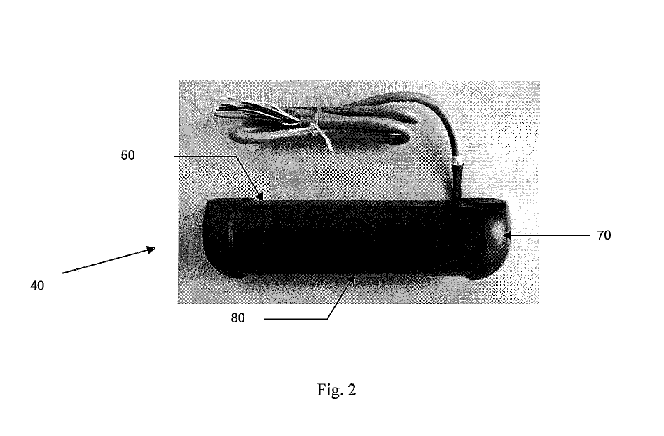

With reference to FIG. 2 and with continuing reference to FIG. 1, housing 50 further includes one or more endcaps 70 and one or more optical elements 80 or lenses to enclose the inner components of sensor device 40. Housing 50 may be manufactured from a variety of materials, including metal and plastic, and is adapted for mounting in a location proximate to a passageway or a passageway barrier, such as door 20. Desirably, housing 50 has a uniform profile such that it may be formed by an extrusion technique. One of ordinary skill in the art will appreciate that the depicted embodiment of housing 50 is for illustrative purposes only, and that housing 50 may be manufactured using a variety of materials and manufacturing techniques.

Each optical element 80 or lens is installed on housing 50 and adapted to pass infrared radiation desirably without distortion or effect on the detection capacity of sensor device 40. Each optical element 80 or lens may be made from a material having high transmissivity for the wavelength of infrared radiation of interest and low transmissivity for all other bands of light. Furthermore, each optical element 80 or lens protects the inner components of sensor device 40 from dirt, inclement weather, and physical destruction.

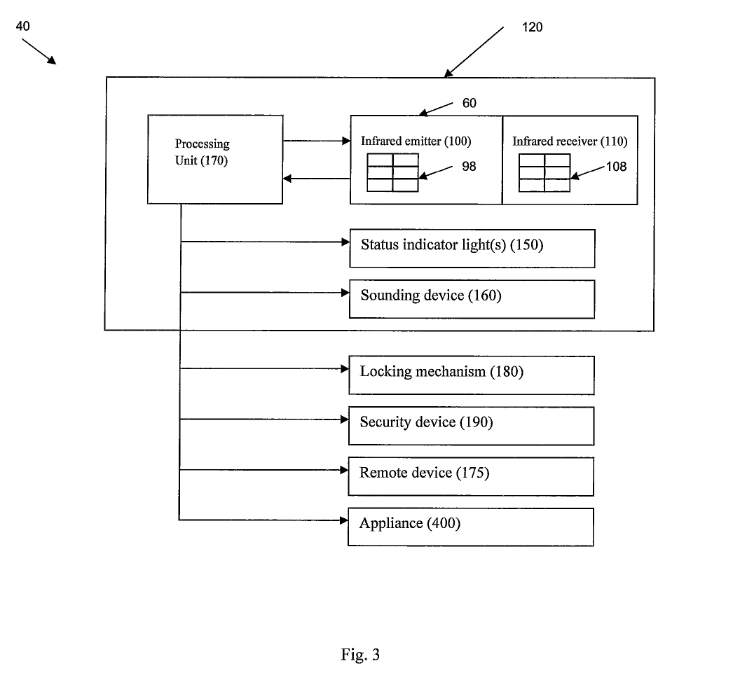

With reference to FIG. 3 and with continuing reference to FIGS. 1 and 2, sensor device 40 includes one or more sensing units 60. Each sensing unit 60 includes one or more infrared light-emitting diodes (ILEDs) 98 that constitute an infrared emitter 100 and one or more position-sensing photodetectors (PSDs) 108 that constitute an infrared receiver 110. In an embodiment where more than one PSD is utilized, the plurality of PSDs 108 for each infrared receiver 110 can be arranged in many suitable and/or desirable arrangements, such as, without limitation, a linear array. Linear or segmented PSDs may be utilized, as will be explained in greater detail hereafter. Each infrared emitter 100 is desirably paired with a corresponding infrared receiver 110. Sensor device 40 may include more than one sensing unit 60 spatially arranged to project a desired pattern of infrared radiation. The area covered by the infrared radiation emitted by one or more infrared emitters 100 defines surveillance area 30. Sensor device 40 includes a processing unit 170 that monitors a change between a first optical signal received by one or more infrared receivers 110 when the object is not present in surveillance area 30 and a second optical signal received by one or more infrared receivers 110 when the object is present in surveillance area 30. A number of sensing units 60 may be arranged linearly, or in a two-dimensional array. Sensing units 60 may be fabricated on a common substrate, such as a single printed circuit board 120. Alternatively, sensing units 60 may be independent from one another and fabricated on dedicated substrates (not shown) that may be electrically coupled. Providing at least two sensing units 60 allows for performing differential measurement between sensing units 60 for more accurate detection of changes within surveillance area 30.

The location and depth of surveillance area 30 is adjusted by moving the physical location of sensor device 40 and/or adjusting the detection angle of sensor device 40. The location and depth of surveillance area 30 may be adjusted by mechanical or electronic means. Lateral adjustment of sensor device 40 is made by installing the sensor in a lateral location whereby the infrared light pattern projected from sensor device 40 is shifted laterally with respect to the passageway. In the embodiment shown in FIG. 1, the lateral location of sensor device 40 is positioned such that it is located directly above door handle 90.

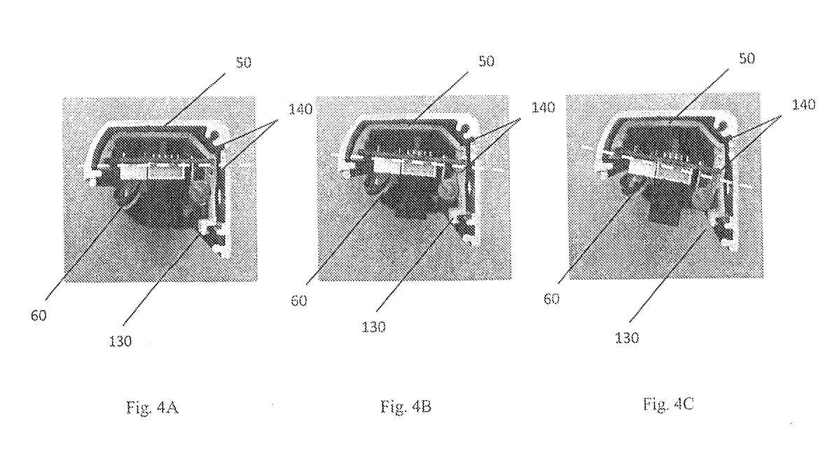

With reference to FIGS. 4A-C and with continuing reference to FIG. 1, the detection angle of sensor device 40 can be mechanically adjusted using one or more mechanical clips 130. The detection angle of sensor device 40 may be adjusted depending on the mounting location of sensor device 40 as well as the desired location of surveillance area 30. The detection angle is adjusted by pivoting one or more sensing units 60 using one or more mechanical clips 130. Each mechanical clip 130 is coupled to housing 50 and includes a plurality of angle adjustment notches 140 that allow each sensing unit 60 to be rotated with respect to housing 50. As shown in FIGS. 4A-4C, the inclination of one or more sensing units 60 may be changed by rotating each sensing unit 60 with respect to housing 50 and locking each sensing unit 60 within an angle adjustment notch 140. Such rotation changes the detection angle of sensor device 40 by moving surveillance area 30 with respect to housing 50.

The depth and width of surveillance area 30 may also be adjusted by regulating the operating parameters of one or more sensing units 60. The depth of coverage may be controlled by adjusting the output of infrared emitter 100. For example, the depth of the surveillance area 30 may be adjusted to define surveillance area 30 at a predetermined distance from housing 50. Referring back to FIG. 1, surveillance area 30 desirably extends between sensor device 40 and door handle 90. In this configuration, sensor device 40 detects objects within surveillance area 30, while objects outside surveillance area 30, such as below or adjacent to door handle 90, are desirably not detected. Additionally, the sensitivity of infrared receiver 110 (FIG. 3) may be adjusted to regulate the detection threshold of sensor device 40. One of ordinary skill in the art will recognize that the adjustment of depth and/or width of surveillance area 30 may be accomplished using a variety of electronic or mechanical means, including dip switches, rotary dials, slide or rocker switches, and other devices capable of controlling the performance of an electronic device. One or more infrared filters or blockers (not shown) can also or alternatively be utilized to cover part of the infrared radiation emitted by one or more infrared emitters 100 in order to precisely define surveillance area 30.

Referring back to FIG. 3, sensor device 40 may further include one or more status indicator lights 150. Each status indicator light 150 may include a plurality of colors indicative of a particular status of sensor device 40. For example, a green status light may indicate that sensor device 40 is powered on and ready for detection. A red status light may indicate that an object is detected in surveillance area 30, or that an auxiliary input, such as a card reader, has been activated. A yellow status light may indicate that door 20 is open but that no object is detected in surveillance area 30 and the auxiliary input has not been activated. One of ordinary skill in the art will appreciate that various colors and lighting sequences may be utilized with each status indicator light 150 without departing from the scope of the claimed invention.

A sounding device 160 including an amplifier circuit (not specifically shown), may be provided for outputting a sound when door 20 is open or when a locking mechanism 180 is in an unlocked state. The device described herein may also include one or more auxiliary electrical inputs for passageway device(s), such as push buttons, door position switches, request-to-exit devices, and/or security card readers. Such passageway device(s) may be paired with a locking mechanism 180 to regulate the operation of door 20.

As discussed above, each infrared emitter 100 and infrared receiver 110 is connected to processing unit 170. Processing unit 170 includes electronic circuitry, including, without limitation, a microprocessor, computer memory, processing circuitry and the like, as needed to control the operation of sensor device 40 and to measure and process optical signals received by one or more infrared receivers 110. Portions or all of such electronic circuitry are desirably part of processing unit 170. The signal processing circuitry associated with each infrared emitter 100 and infrared receiver 110 pair generates one or more signals related to an object's detection distance from sensor device 40.

With the basic structure of system 10 now described, the operating principle of sensor device 40 will now be described. In various embodiments, sensor device 40 is utilized to control the operation of a passageway barrier, such as door 20, wherein a request to enter or exit a secure side of a passageway barrier is determined by sensing the presence of an object within surveillance area 30. Sensor device 40 may be coupled with one or more other access control devices to regulate ingress and egress to and from a secure side of a passageway barrier. In some embodiments, sensor device 40 is coupled to locking mechanism 180, such as, without limitation, an automatic lock.

Each sensing unit 60 is operative for projecting a pattern of infrared light to define surveillance area 30. More specifically, the infrared emitter 100 of each sensing device 60 projects a pattern of infrared light through one or more optical elements 80 or lenses of housing 50. Processing unit 170 determines whether there is any change in an angle of reflection between a first optical signal received by infrared receiver 110 when an object is not in surveillance area 30 and a second optical signal received by infrared receiver 110 when the object is in surveillance area 30. Based on this change, processing unit 170 determines whether the difference in the reflected signal exceeds a predetermined threshold value, such condition being indicative of the object being within surveillance area 30. Also or alternatively, processing unit 170 compares an optical signal detected by infrared receiver 110 against a predetermined threshold value. If the detected optical signal differs from a predetermined threshold value, such condition is indicative of the object being within surveillance area 30. If the change in the optical signal corresponds to the characteristics of an optical signal indicative of a predetermined condition, such as a person's hand entering surveillance area 30, processing unit 170 sends an unlock signal to locking mechanism 180. If door 20 is equipped with an automatic door opener (not shown), processing unit 170 may also send a signal to activate the automatic door opener to open door 20.

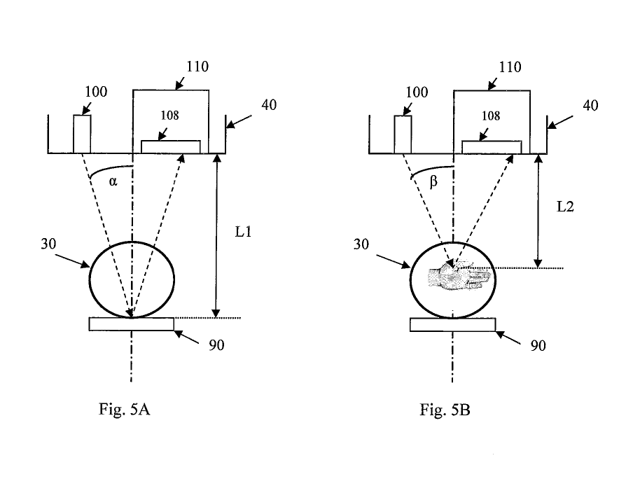

With reference to FIGS. 1, 3, 5A, and 5B, a first embodiment of sensor device 40 is illustrated. In this embodiment, infrared receiver 110 includes a lateral PSD 108 provided as a single, continuous element. Sensor device 40 having a single lateral PSD 108 detects a change between a first signal generated by lateral PSD 108 receiving reflected infrared radiation at a first location on lateral PSD 108 and a second signal generated by lateral PSD 108 receiving reflected infrared radiation at a second location on lateral PSD 108, which is directly correlative to the distance of the object entering surveillance area 30 from sensor device 40. More specifically, in use of lateral PSD 108, optically generated photocurrent output by lateral PSD 108 changes as a function of the received light position on the light receiving surfaces of lateral PSD 108 to determine the distance of the object in surveillance area 30 from sensor device 40. Referring to FIG. 5A, during normal operating conditions, such as when door 20 is closed and no object is present in surveillance area 30, one or more infrared emitters 100 emit infrared radiation to define surveillance area 30. At least some of infrared radiation emitted by one or more infrared emitters 100 is reflected and detected by one or more infrared receivers 110, with each receiver having a single, lateral PSD 108. More specifically, infrared radiation reflected by, for example, and without limitation, door handle 90, is received at a first location on lateral PSD 108. In this manner, a first signal is generated by lateral PSD 108, which corresponds to the location where the reflected infrared radiation strikes lateral PSD 108. The transmitted and received infrared radiation define an angle α. This angle is directly correlative to distance L1 between sensor device 40 and handle 90.

With reference to FIGS. 1 and 5B, once an object, such as a human hand, enters surveillance area 30, there is a change in the angle between the transmitted and received infrared radiation. Infrared radiation reflected from the object is detected at a second location on lateral PSD 108, which is different compared to the first location illustrated in FIG. 5A. A second signal is generated by lateral PSD 108, which corresponds to the location where the reflected infrared radiation strikes lateral PSD 108. Under these circumstances, the transmitted and received infrared radiation beams define an angle β. This angle is directly correlative to distance L2 between sensor device 40 and the object in the surveillance area. The closer the object is to sensor device 40, the larger angle β becomes. Based on whether the difference between angle α and angle β is greater than or equal to a first predetermined threshold value, processing unit 170 determines whether such angular change is due to the presence of a valid object, such as a human hand. For example, the threshold value may be set to correspond to a distance L2 that is equivalent to a distance between a person's hand placed on door handle 90 and sensor device 40. If the difference between angle α and angle β is greater than or equal to the first predetermined threshold value, processing unit 170 will cause locking mechanism 180 to unlock door 20. In response to differences between angle α and angle β that are below the first predetermined threshold value, processing unit 170 will not cause locking mechanism 180 to unlock door 20.

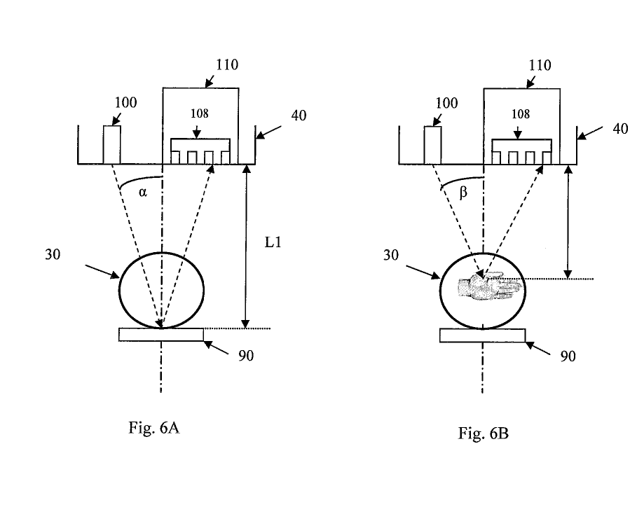

With reference to FIGS. 6A, and 6B, an alternate embodiment of sensor device 40 is illustrated. In this embodiment, infrared receiver 110 includes a plurality of segmented PSDs 108 arranged in an array with a gap formed between the adjacent PSDs. As in the previously described embodiment where a single lateral PSD 108 is used, sensor device 40 having a plurality of segmented PSDs also detects a change between first and second optical signals, which is directly correlative to the distance of the object entering surveillance area 30 from sensor device 40.

Referring to FIGS. 1 and 6A, during normal operating conditions, such as when door 20 is closed and no object is present in surveillance area 30, one or more infrared emitters 100 emit infrared radiation to define surveillance area 30. At least some of infrared radiation emitted by one or more infrared emitters 100 is reflected and detected by one or more infrared receivers 110. More specifically, infrared radiation reflected by, for example, without limitation, door handle 90 is detected by a first subset of PSDs 108 of the one or more infrared receivers 110. The transmitted and received infrared radiation define an angle α. This angle is directly correlative to distance L1 between sensor device 40 and handle 90.

With reference to FIGS. 1, 3, 6A, and 6B, once an object, such as a human hand, enters surveillance area 30, there is a change in the angle between the transmitted and received infrared radiation. Infrared radiation reflected from the object is detected by a second subset of PSDs 108 of the one or more infrared receivers 110 compared to the condition illustrated in FIG. 6A. Under these circumstances, the transmitted and received infrared radiation beams define an angle β. This angle is directly correlative to distance L2 between sensor device 40 and the object in the surveillance area. The closer the object is to sensor device 40, the larger angle β becomes. Based on whether the difference between angle α and angle β is greater than or equal to a first predetermined threshold value, processing unit 170 determines whether such angular change is due to the presence of a valid object, such as a human hand. For example, the threshold value may be set to correspond to a distance L2 that is equivalent to a distance between a person's hand placed on door handle 90 and sensor device 40. If the difference between angle α and angle β is greater than or equal to the first predetermined threshold value, processing unit 170 will cause locking mechanism 180 to unlock door 20. In response to differences between angle α and angle β that are below the first predetermined threshold value, processing unit 170 will not cause locking mechanism 180 to unlock door 20.

Optical signals that reflect from an object within surveillance area 30 can be detected based on triangulation, pulse frequency, and/or angular separation between the optical signals. Processing unit 170 determines if the reflected optical signals are the result of one or more of a plurality of conditions, including an environmental abnormality (such as a temperature change or background lighting change); the result of a nuisance event such as an object passing over door handle 90, whereupon, the difference between angle α and angle β is greater than a second predetermined threshold value that is greater than the first predetermined threshold value, or an object passing parallel to the passageway without the intent of passing through the passageway; the result of a precarious event such as a person attempting to gain unauthorized entry from the non-secure side of the passageway using an object that could pass through cracks in the passageway; and/or the result of a proper event, such as a person reaching for the passageway element to proceed through door 20. Each of the above conditions can be associated with a corresponding change in the angle of the reflected optical signals.

Processing unit 170 controls the state of locking mechanism 180 in either a locked or unlocked state based on the absence or presence, respectively, of an object in surveillance area 30. For example, the default condition of door 20 may be in a closed state with locking mechanism 180 engaged to keep door 20 in a closed state. When there is no object detected in surveillance area 30, door 20 remains locked. Once an object, such as a human hand, is inside surveillance area 30, there is a change between angle α when the object is not present in surveillance area 30 and angle β when the object is present in surveillance area 30. If processing unit 170 determines that such angular change is indicative of a valid object being present in surveillance area 30, processing unit 170 sends an unlock signal to locking mechanism 180. This in turn causes locking mechanism 180 to unlock door 20 and allow door 20 to be opened.

Processing unit 170 controls the state of locking mechanism 180 based on an opened or closed state of door 20; and/or based on time. For example, processing unit 170 causes locking mechanism 180 to unlock door 20 once a desired object is detected in surveillance area 30. Once door 20 is opened, either manually or via an automatic door opener under the control of processing unit 170, locking mechanism 180 is released from the unlocked state, such that when door 20 is closed again, it locks and cannot be opened without a subsequent detection of the desired object within surveillance area 30. Additionally, processing unit 170 may cause locking mechanism 180 to keep door 20 unlocked for a predetermined amount of time before re-engaging it, whereupon processing unit 170 releases locking mechanism 180 from its unlocked state, whereupon when door 20 closes again, locking mechanism 180 locks door 20 in a closed state until there is a subsequent detection in surveillance area 30.

After the object passes through door 20 and/or leaves surveillance area 30, processing unit 170 releases locking mechanism 180 to return to its locked state. In this case, door 20 is locked after it is closed. In an embodiment where door 20 is equipped with an automatic door opener, processing unit 170 may also send a signal to activate the automatic door opener to close door 20.

In an embodiment where door 20 is provided with sounding device 160 capable of outputting a sound when door 20 is opened, processing unit 170 may control sounding device 160 in either a silent or alarm state with adjustable amplitude based on a plurality of conditions, including, without limitation, optical signals received by infrared receiver 110; the opened or closed state of door 20; and/or time during which door 20 remains open. For example, an audible alarm may be sounded once locking mechanism 180 is disengaged and/or door 20 is open. Also or alternatively, processing unit 170 may cause the same or a different audible alarm to be activated if door 20 is left open for longer than a predetermined period of time. Also or alternatively, processing unit 170 may control an opened or closed state of door 20 and/or the time during which door 20 remains open. In another alternative embodiment, sounding device 160 is provided as part of sensor 40. In an embodiment where sensor device 40 is associated with an automatic door opener (not shown), processing unit 170 can control the operation of the automatic door opener.

The detection of infrared radiation may be based on time of flight, spectral (light spectrum) content; and/or optical intensity. To this end, processing unit 170 can continuously sample signals detected by one or more infrared receivers 110 and compare them to determine whether any changes between successive signals may be indicative of an object being present in surveillance area 30. For example, processing unit 170 may calculate the time it takes for the reflection of infrared light emitted from one or more infrared emitters 100 to be reflected back from door handle 90 or an object and detected by one or more infrared receivers 110. Alternatively, processing unit 170 may analyze the intensity and/or spectral content of light detected by one or more infrared receivers 110. The optical signals output by infrared emitter 100 and/or received by infrared receiver 110 may be collimated, focused, and/or diffused. Each infrared emitter 100 may include angular adjustment devices (not shown), such as movable mirrors, to create a plurality of spatially and independently adjustable optical signals from one or multiple sources.

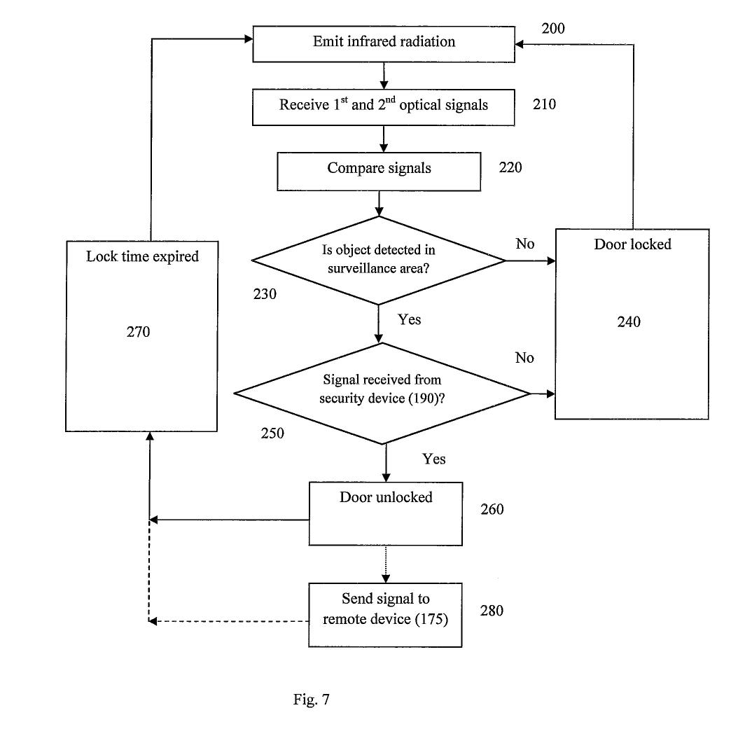

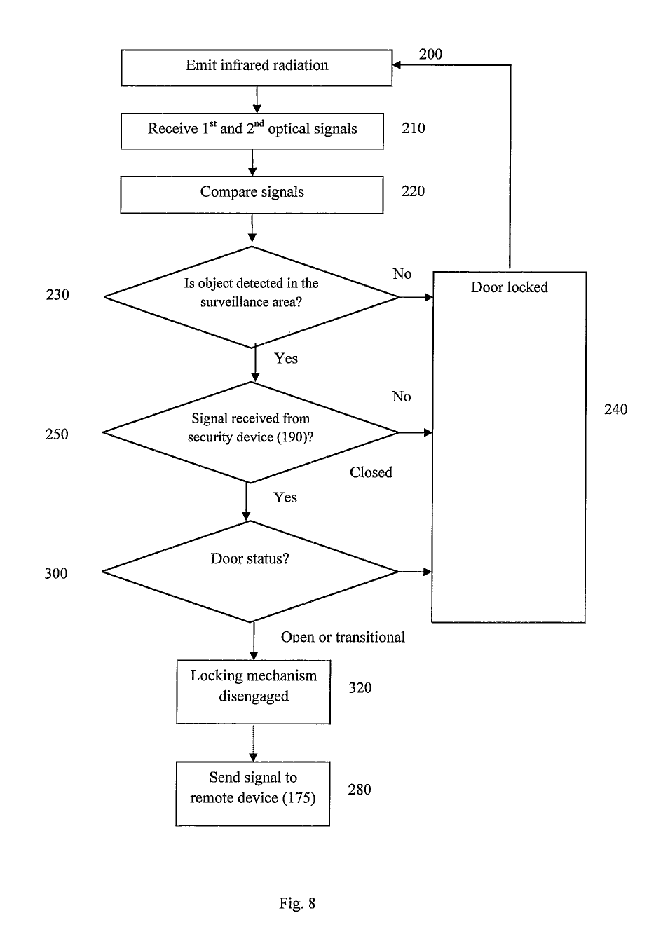

With the basic structure and operating principles of system 10 now described, methods of operation of sensor device 40 will now be described in accordance with various embodiments and with reference to FIGS. 7 and 8. In the described embodiments, sensor device 40 is provided over a passageway having a swinging door controlled by locking mechanism 180, such as a magnetic door lock; however, it is to be understood that the described embodiments are exemplary only, and that the claimed device and method may be utilized with a plurality of different door and locking mechanism combinations.

In FIG. 7, a method of controlling passageway locking mechanism 180 begins at step 200 where sensor device 40 emits infrared radiation from one or more infrared emitters 100. At step 210, one or more PSDs 108 on one or more infrared receivers 110 receive a first optical signal corresponding to angle α in FIGS. 5A-5B and 6A-6B and a second optical signal corresponding to angle β in FIGS. 5A-5B and 6A-6B. At step 220, processing unit 170 compares the first optical signal and the second optical signal and determines in step 230 whether the angular change between the first signal and the second signal is indicative of a valid object detected within surveillance area 30. If, in step 230, the angular change between the signals corresponds to an object not being detected within surveillance area 30, processing unit 170 in step 240 causes locking mechanism 180 to keep door 20 locked. Conversely, if, in step 230, the angular change between the signals corresponds to an object being detected within surveillance area 30, an optional inquiry of whether a signal is received from a manual or automatic security device 190 is taken at step 250. Security device 190 may be a passageway switch, a push plate, an emergency door release button located in proximity to door 20, a mechanical hardware lock and key, an electronic security card reader, an encrypted key-fob receiver, or a secure biometric reader located in proximity to door 20. Such security device 190 may be connected to processing unit 170 and may send and receive electrical signals. If no signal is received from security device 190 at a suitable time before and/or after a valid object is detected in surveillance area 30, processing unit 170 causes locking mechanism 180 to keep door 20 locked. Conversely, if a signal is received from security device 190 before and/or after such suitable time, processing unit 170 causes locking mechanism 180 to unlock door 20 at step 260. After a predetermined amount of time, processing unit 170 causes locking mechanism 180 to relock door 20. At optional step 280, processing unit 170 sends a signal to a remote device 175 located on the same or opposite side of the passageway barrier. Remote device 175 may include alarm elements, lock elements, sounding elements, and/or signaling elements. In some embodiments, processing unit 170 sends a signal.

In this embodiment, an object desirably activates security device 190 before attempting to gain access through door 20. Processing unit 170 causes locking mechanism 180 to unlock door 20 after the object activates manual device 190 and valid change between the first and second optical signals is detected within surveillance area 30. Optionally, processing unit 170 may activate remote device 175, such as an alarm, a video surveillance system, or passageway lighting, when door 20 is unlocked.

In another embodiment of the present invention illustrated in FIG. 8, a method of controlling passageway locking mechanism 180 includes steps 200-250 described above in connection with the embodiment illustrated in FIG. 7. An inquiry of whether door 20 is open or closed is taken at step 300. If door 20 is closed, processing unit 170 causes locking mechanism 180 to keep door 20 locked in step 240. If door 20 is open or in a transitional state between open and closed, processing unit 170 causes locking mechanism 180 to keep door 20 unlocked at step 320. An appliance 400 (FIG. 3) determines whether door 20 is open, closed, or in a transitional state. Appliance 400 can include, but is not limited to, a magnetic reed switch, an optical encoder, a gyroscope, a photo-eye, magnetometer, or a mechanical switch, located adjacent to door 20. Processing unit 170 may also or alternatively analyze the open, closed or transitional state of door 20 and control the operation of remote device 175, including alarm elements, lock elements, sounding elements, and/or signaling elements. For example, processing unit 170 may activate an alarm, a video surveillance system, or passageway lighting when door 20 is unlocked. At optional step 280, processing unit 170 sends a signal to a remote device 175 located on the same or opposite side of the passageway barrier. Remote device 175 may include alarm elements, lock elements, sounding elements, and/or signaling elements. In some embodiments, processing unit 170 sends a signal.

While the device and method of the present invention have been described with respect to preferred embodiments, various modifications and alterations of the present invention may be made without departing from the spirit and scope of the present invention. For example, the one or more optical signals and the means for generating said one or more optical signals, and detecting reflection(s) thereof, can be replaced by a suitable means that actively outputs a signal and detects the presence of an object, such as a hand, in the path of said output signal. The scope of the present invention is defined in the appended claims and equivalents thereto.

The invention claimed is:

1. An active infrared sensor device comprising:
at least one infrared emitter operative for emitting a pattern of infrared light to define a surveillance area;
at least one infrared receiver having one or more position-sensing photodetectors (PSDs) operative for receiving infrared light reflected from the surveillance area and for generating a signal corresponding to a position and/or intensity of the reflected infrared light; and
a processing unit operative for detecting a change between a first signal generated by the one or more PSDs in response to receiving reflected infrared light prior to an object moving into the surveillance area at a first location on the one or more PSDs and a second signal generated by the one or more of the PSDs in response to receiving infrared light reflected from the object after moving into the surveillance area at a second location on the one or more PSDs and for controlling an operation of a locking mechanism of a passageway barrier based on said change.

2. The active infrared sensor device according to claim 1, wherein the processing unit causes the locking mechanism to unlock the passageway barrier in response to the processing unit detecting said change and causes the locking mechanism to either lock the passageway barrier or maintain the passageway barrier locked in response to the processing unit not detecting said change.

3. The active infrared sensor device according to claim 1, further comprising one or more optical elements in the path of the at least one infrared emitter or the at least one infrared receiver, wherein the one or more optical elements have high transmissivity to infrared radiation and low transmissivity to radiation outside the infrared spectrum.

4. The active infrared sensor device according to claim 1, further comprising one or more mechanical clips having a plurality of angle adjustment notches corresponding to a plurality of detection angles of the at least one infrared emitter or the at least one infrared receiver, wherein the detection angle is adjusted by pivoting the at least one infrared emitter or the at least one infrared receiver to engage an angle adjustment notch.

5. The sensor device according to claim 2, further comprising a sounding device activated by an unlocked state of the locking mechanism.

6. A method of controlling a locking mechanism comprising the steps of:
(a) providing a sensor device configured to detect an object within a surveillance area, the sensor device comprising:
at least one infrared emitter operative for emitting infrared light to define the surveillance area;
at least one infrared receiver having one or more position-sensing photodetectors (PSDs) operative for receiving infrared light reflected from the surveillance area and for generating a signal corresponding to a position and/or intensity of the reflected infrared light; and
a processing unit;
(b) the infrared emitter emitting infrared radiation;
(c) the one or more PSDs generating a first signal in response to receiving reflected infrared light prior to the object moving into the surveillance area at a first location on the one or more PSDs and the one or more PSDs generating a second signal in response to receiving infrared light reflected from the object after moving into the surveillance area;
(d) the processing unit detecting a change between the first and second signals; and
(e) the processing unit controlling an operation of the locking mechanism based on said change.

7. The method of claim 6, further comprising the steps of:
(f) receiving a signal from a security device; and
(g) sending a signal to a remote device.

8. The method of claim 7, wherein the security device is a passageway switch, a push plate, an emergency door release button, a mechanical hardware lock and key, an electronic security card reader, an encrypted key-fob receiver, a secure biometric reader, an RFID tag transponder, or a video identification system.

9. The method of claim 7, wherein the remote device is a fire alarm, a secondary device or a video system.

10. The method of claim 6, further comprising the steps of:
(f) receiving a signal from an appliance corresponding to an open, a closed, or a transitional state of the passageway barrier; and
(g) using one or more sensing means, including capacitive, inductive, magnetic, microwave, optical, and physical contact, to monitor the state of the passageway barrier.

11. The method of claim 10, wherein the appliance is a magnetic reed switch, an optical encoder, a gyroscope, a photo-eye, magnetometer, or a mechanical switch.

12. The method of claim 10, further comprising a sounding device activated by an unlocked state of the locking mechanism.

13. An access control system comprising:
a passageway having a passageway barrier for selectively controlling access through the passageway;
an active infrared sensor device for detecting an object within a surveillance area adjacent to the passageway; and
a locking mechanism operative for selectively locking and unlocking the passageway barrier in response to the active infrared sensor device not detecting and detecting, respectively, the object within the surveillance area.

14. The access control system of claim 13, wherein the active infrared sensor device comprises:
an infrared emitter operative for emitting a pattern of infrared light to define the surveillance area;
an infrared receiver having one or more position-sensing photodetectors (PSDs) operative for receiving infrared light reflected from the surveillance area and for generating a signal corresponding to a position and/or intensity of the reflected infrared light; and
a processing unit operative for detecting a change between a first signal detected by the one or more PSDs in response to receiving reflected infrared light prior to an object moving into the surveillance area at a first location on the one or more PSDs and a second signal detected by the one or more PSDs in response to receiving infrared light reflected from the object after moving into the surveillance area at a second location on the one or more PSDs and for controlling an operation of a locking mechanism of a passageway barrier based on said change.

15. The access control system of claim 14, wherein the processing unit causes the locking mechanism to unlock the passageway barrier in response to the processing unit detecting the change between the first and second signals that is above a predetermined threshold value and controlling the locking mechanism to either lock the passageway barrier or maintain the passageway barrier locked in response to the processing unit detecting the change between the first and second signals that is below the predetermined threshold value.

16. The access control system of claim 14, further comprising one or more mechanical clips having a plurality of angle adjustment notches corresponding to a plurality of detection angles of the infrared emitter or the infrared receiver, wherein the detection angle is adjusted by pivoting the infrared emitter or the infrared receiver to engage an angle adjustment notch.

17. The access control system of claim 14, further comprising a security device adjacent to the passageway operative for opening the passageway barrier.

18. The access control system of claim 17, wherein the security device is a passageway switch, a push plate, an emergency door release button, a mechanical hardware lock and key, an electronic security card reader, an encrypted key-fob receiver, a secure biometric reader, an RFID tag transponder, or a video identification system.

19. The access control system of claim 14, wherein the one or more PSDs comprises a lateral PSD.

20. The active infrared sensor device of claim 1, wherein the one or more PSDs comprises a lateral PSD or a segmented PSD.
